(19) United States
(12) Patent Application Publication
(10) Pub. No.: US 2011/0309805 A1
(43) Pub. Date: Dec. 22, 2011

(54) METHOD FOR OPERATING A DOUBLY FED PERMANENT MAGNET SYNCHRONOUS MACHINE, AND A SYSTEM COMPRISING SUCH A MACHINE AND A CONVERTER

(75) Inventors: Alexey MATVEEV, Trondheim (NO); Tore SKJELLNES, Trondheim (NO); Sigurd OVREBO, Levanger (NO)

(73) Assignee: SMARTMOTOR AS, Trondheim (NO)

(21) Appl. No.: 13/161,819

(22) Filed: Jun. 16, 2011

Related U.S. Application Data
(63) Continuation-in-part of application No. PCT/NO2009/000436, filed on Dec. 16, 2009.

(30) Foreign Application Priority Data
Dec. 19, 2008 (NO) 29985321

(51) Int. Cl. H02P 9/48

(52) U.S. Cl. 322/61

(57) ABSTRACT

A method for operating a doubly fed permanent magnet synchronous machine and a system including such a machine and a converter for feeding and withdrawal of power. The machine has two or more winding groups where at least one winding group is connected directly to a grid and at least one winding group has the possibility to be connected to the grid via a power electronics converter or directly.

This application is a continuation-in-part of PCT/NO2009/000436 filed Dec. 16, 2009, which claims the priority of Norwegian Application 20085321 filed Dec. 19, 2008, the contents of both prior applications being incorporated herein by reference.

### BACKGROUND OF THE INVENTION

The invention comprises a method for operation of a doubly fed permanent magnet synchronous machine, and a system having such a machine and a converter.

Current proposals for feeding and control of electric machines are dominated by three-phase feeding. The connection may be direct or via a converter. In some cases the rotor is feed by collector rings and converter.

Usual prior art systems with field fed synchronous machines (Electric Machines, Theory, Operation, Applications, Adjustment, and Control, Charles I Hubert. ISBN 0-675-21136-0, page 305-308) have a fixed grid frequency. In such systems the active power and the reactive power may be controlled. In generator systems, the power is controlled by controlling the energy supplied (wind, water, gas, steam, etc.). The reactive power is controlled by controlling the current of the field winding. At over magnetizing reactive power fed into the system, this is normally increasing the voltage (provided inductive load angle). At too low magnetizing, reactive power from the grid, with inductive load angle, the voltage will decrease. In usual synchronous machines, a magnetizing machine and an auxiliary motor (same source) are used. The magnetizing machine provides collector less transfer of the magnetizing current. The auxiliary motor (starting machine) is running the machine to synchronous rotation. It is possible to combine the magnetizing machine and the auxiliary motor as described in PCT application WO 85/02886.

In modern, permanent magnet synchronous machine (PMSM) systems, converters are normally used for connecting the machine to the grid. The converter provides a decoupling between grid and machine which allows operation at variable rotational speed and control of active and reactive power flow to and from the grid. The drawback is the cost of the converter which in some cases is equal to the machine cost.

During the last decades, systems have been proposed with partial converter feeding to provide increased functionality. An example is the double fed asynchronous machine shown in Electric Machines, Theory, Operation, Applications, Adjustment, and Control, Charles I Hubert. ISBN 0-675-21136-0, Chapter 8. The stator is fed directly from the grid, while the rotor is fed via a converter and collector rings. This configuration provides increased functionality with only ⅓ converter rating. Another example of prior art technology is the synchronous machine with a stator connected directly to the grid, while the field circuit has a converter. Also the converter has a power rating substantially less than the nominal rating of the generator. On slower rotating machines, conventional synchronous machines will require unsuitable large diameter to accommodate the magnetizing windings. In such cases a permanent magnet synchronous machine (PMSM) is a favorable alternative. The drawback of PMSM machines is that the field cannot be controlled with a field winding and a converter rated for the whole machine power is needed to control it. In some applications PMSM machines are connected directly to the grid and are operated as motor or generator. This configuration may be used in a system with a stable speed. Due to the fixed voltage/speed curve of the PM machine, the flow of reactive power cannot be controlled in such systems. An alternative control for such systems is to install a parallel source of reactive power. Such sources can be established with staged static condensers or switched condenser assemblies (STATCOM). The drawback of such systems is the high cost.

“Soft Starter” is a notion used for systems with devices for providing a better start in regard of start current and transient torque (Design of Intelligent Soft-Start Controller for Induction Motor, Wen-Xiong Li, Jian-GuoLv, Ming-Sheng Lw., Proceedings of the Third International Conference on Machine learning and Cybernetics, Shanghai, 26-29 Aug. 2004). Typical for such systems is the use of thyristors connected in series to the stator winding. The thyristors are ramping up the voltage to the stator, to provide a softer start than direct starting. This type of equipment cannot give the functionality as a full bridge converter regarding torque/speed control when starting. Serial connected thyristors provide less control than a full bridge configuration, which by use of advanced vector control can control all kinds of machines optimally. Serial connection of thyristors has also been proposed to control active and reactive power.

Other prior art shows PMSM machines connected to the grid with the possibility to connect a converter configuration on to the grid connection and possibly disconnect the grid connection entirely. Such solutions can be found in ABB Research's WO2007027141A1 patent application from Aug. 3, 2007. The drawback of such systems is that the voltage levels on the converter must be the same as the grid without using a transformer.

### SUMMARY OF THE INVENTION

The main object of the invention is to reduce costs and size of an energy conversion system, with a machine and converter occupying less space than a corresponding synchronous machine.

It is also an object to provide a system with a higher efficiency compared with system with full converter.

Further objects will appear from the following description of the invention and its embodiments. The method according to the invention is based on double feeding of the stator of a permanent magnet synchronous machine. The double feeding is achieved by using the combination of a direct feeding and a converter feeding of a stator, where at least one of the winding groups is directly connected to a grid and at least one winding group has the possibility to be connected to the grid via a power electronics converter or directly. This provides more advantages compared to prior art technology. The advantages of different machine types are stated more specifically in the following examples. The invention may be called “double fed permanent magnet synchronous machine” (DFPMSM).

The invention also comprises an electric system including a permanent magnet synchronous machine, which comprises a system with a permanent magnet synchronous machine, such as a motor or a generator, with a converter for feeding or withdrawal of power, the novelty being the converter being provided to feed or withdraw a power substantially lower than the maximum power of the system, that the machine comprises more than one winding group, and that at least one winding group is directly connected to a grid and at least one winding group has the possibility to be connected to the grid via a converter. This system has corresponding advantages as the method described.

The converter may be rated for less than approximately 50% of the total power (nominal power).

The invention may be used with different permanent magnet machines, both rotational and linear, motors as well as generators.

Permanent magnet synchronous machines today are thus connected directly to the grid or connected over a full converter (with the nominal power of the machine). By combining both kinds of connection of the stator, it is possible to have a solution operating at constant velocity with control of the reactive power flow. The difference between the prior art and the novel solution is that the double feeding of the prior art systems feeds the same stator windings directly, or via a converter, while the novel invention has a feeding to separate winding groups.

The novel system has reduced costs compared to a full converter solution, but will provide a substantial part of the same functionality. Additionally to controlling the reactive power supply, the converter may be used for controlling the torque. This novel solution has no brushes or collector rings and will thus need substantially less maintenance than prior art systems like a Double Fed Induction Generator (DFIG).

The size of the converter fed part will vary according to the requirements for control of the system. The requirements for coupling vary from country to country. In Norway, the proprietor of the grid is issuing the requirements. In the advice for grid connection, systems larger than 10 MW have particular connection requirements. These requirements imply that novel systems should be designed to contribute to control the active and reactive power during different conditions of operation in the grid.

For such systems, the requirement for the converter fed part of the system reaches 50%. For smaller systems (<10 MW), the invention will make the system more resistant to malfunction of the system. On voltage changes, the system may deliver reactive power to the grid. For smaller system (<10 MW) the requirements of the grid proprietor will not guide the system design. In such systems the requirement for stable voltage will be most important. If one or more generator systems provide a voltage changes or frequency changes exceeding the limits for the output quality, the power supplier will be responsible for possible damage to the electric system. At the consumer side, damage occurs to equipment normally when the voltage is too high or too low. When using conventional permanent magnet synchronous generators, the terminal voltage of the generator system is controlled, to avoid damage at the consumer side.

Furthermore, doubly fed permanent magnet machines with only one winding group, often use a transformer to connect the converter to the machine windings. By having separate winding groups, this transformer can be avoided. The number of turns in the windings connected to the converter may also be different from the other windings so that the current and voltage levels correspond to the converter.

The converter to be used according to the invention may be a standard converter. There is no limitation to the type of switches or topologies to be used. One example may be a full bridge converter using IGBT (Insulated Gate Bipolar Transistor) technology. Said two converter parts are typically connected with a DC connection.

### BRIEF DESCRIPTION OF THE DRAWINGS

The invention is now described with reference to the drawings, in which:

FIG. 1 is a schematic diagram of a system according to the invention;

FIG. 2 is a schematic diagram of a system with two machines on the same shaft;

FIG. 3 is a schematic diagram of a system with a filter or transformer;

FIG. 4 is a schematic diagram of an alternative embodiment of the invention, with a double fed stator; and

FIGS. 5 and 6 are schematic diagrams showing alternative embodiments of the double fed system.

### DESCRIPTION OF THE PREFERRED EMBODIMENTS

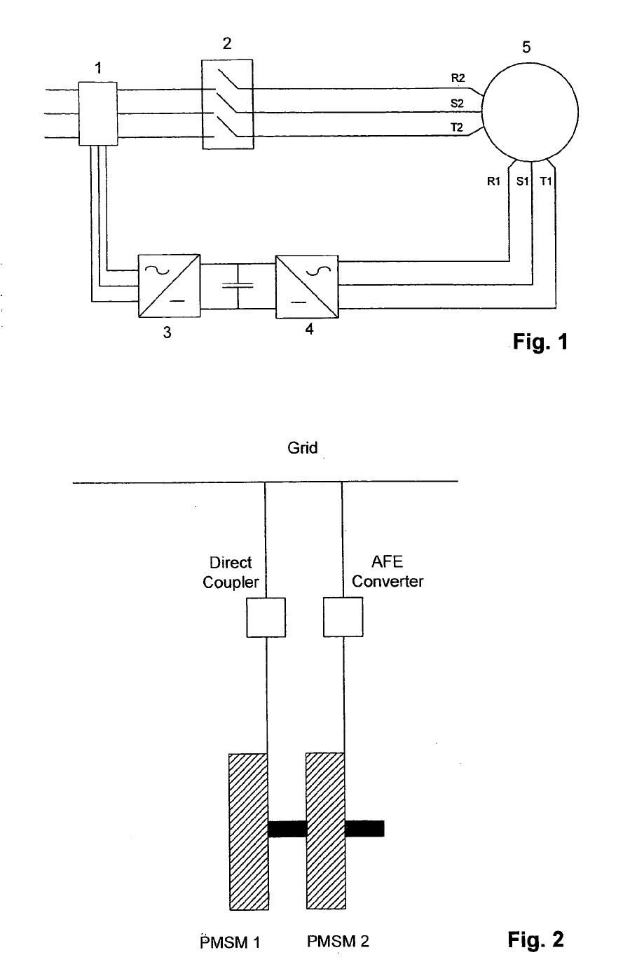

An integrated solution is shown in FIGS. 1. R1, R2, S1, S2, T1, and T2 denote windings connected to two separate zero points. The windings are grouped to make each group a three phase system. Group 1 consists of R1, S1, T1. Group 2 consists of R2, S2, T2. Group 1 is connected to the grid through a converter 3. Group 2 is connected directly to the grid through a grid connector 2. When the machine is started, the rotor is accelerated with the converter 3. It is possible to use the converter controlled part for operating at changing speeds. This may be useful in a wind power system when withdrawing a reduced power at low speeds, or in a propeller system with pitch control.

In FIG. 1:

1 denotes a connector between the direct connection and the converter. It may contain grid filters and/or transformers;

2 denotes a connector for making a direct connection, which may be mechanical (a contactor) or electronic (power electronics);

3 denotes an AC-DC converter inside the frequency converter system that is connected to the grid;

4 denotes a DC-AC converter inside the frequency converter system that is connected to the electric machine; and

5 denotes an electric machine.

In FIG. 2, a system is shown with two machines on the same shaft. This principle can also be used in systems without a common shaft for starting an engine with an alternative admission (e.g. water or steam).

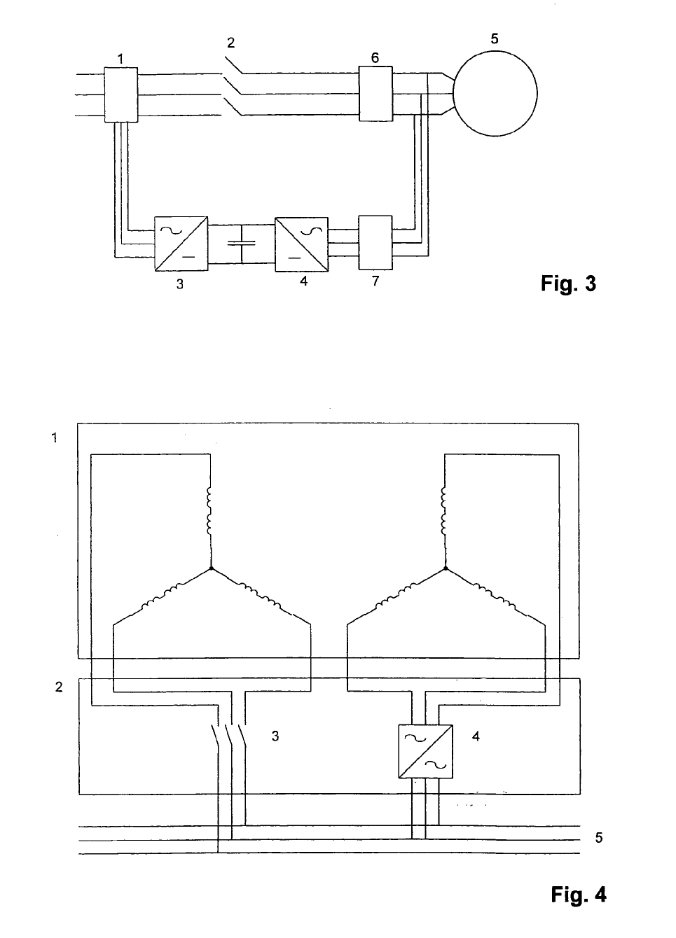

In FIG. 3:

1 denotes a connector between the direct connection and the converter. It may contain grid filters and/or transformers;

2 denotes a connector for making a direct connection, which may be physical (a contactor) or electronically (power electronics);

3 denotes a, AC-DC converter inside a frequency converter system connected to the grid;

4 denotes a DC-AC converter inside a frequency converter system connected to the electric machine;

5 denotes an electric machine;

6 denotes a filter or a transformer (may also be operated without); and

7 denotes a filter or a transformer (may also be operated without).

The connection assembly shown in FIG. 3 is according to prior art. The converters 3, 4 of FIG. 3 may be common full bridge converters or other converter concepts, e.g. a multi-level converters. Converters with switches that can close independently are favorable, e.g. IGBT switches.

In FIG. 3, the converters are connected over the direct connection via a filter or grid transformer. The filter may be L or LCL for this kind of system. The rating of the filter together with the converter will govern the part of the power to be controlled.

By using the converter, the reactive and the active power may be controlled. The system may also be controlled without disturbance of the grid. If only the direct connection is used, maximum efficiency may be achieved for some operation modes.

The last solution is optimal in regard of efficiency, as the system may deliver full power without using the converter. The converter mode of operation may be changed between passive, synchronizing, starting, stopping, reactive compensator and more.

The operation with optimum efficiency is particularly important when generating power, but also important in systems with high cooling requirements. This may be the case in down hole operations with high surface temperatures. With the system of FIG. 3, a system may be provided using power electronics during start and operation to reduce the losses.

FIG. 4 shows an alternative to the electric system of FIG. 1, in which:

1 denotes a stator of an electric machine (6 phase);

2 denotes a connection to a grid;

3 denotes a direct connection;

4 denotes a frequency converter; and

5 denotes a grid.

FIG. 4 is a schematic illustration of a double fed stator. The stator 1 has 6 phases. Three of the phases are connected to the direct connection 3, while three of the phases are connected to the converter 4. Both supplies are connected to the grid 5 to have the stator double fed. Additionally the system may also have filters and transformers. Contactors may be arranged to allow bypass and/or parallel connection of the converter.

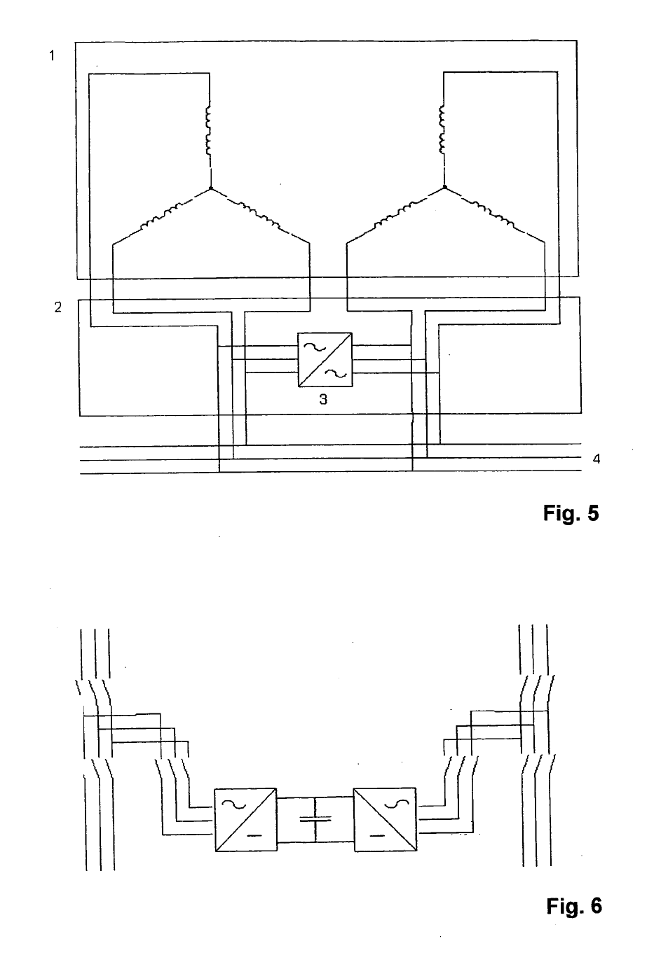

In FIGS. 5 and 6:

1 denotes a stator of an electric machine (6 phase);

2 denotes a connection to a grid; and

3 denotes a frequency converter,

FIG. 5 is showing an alternative connection of the double fed system. In this case, the converter is connected between the two separate sets of windings. FIG. 6 is showing a possible connection for the converter in FIG. 5. The configuration in FIGS. 5 and 6 will allow all advantages of a double feeding (start, braking, reactive power control, damping of transients etc.).

A further advantage of the described invention is when the DC-link of the converter includes a braking resistor. In the case of grid connection loss, the winding groups can all deliver power through the converter to the barking resistor to stop the machine. In an example with two winding groups and a converter system rated for ½ of the total machine power, the converter is able to brake the machine with full power. This can be done because both winding groups can deliver a power half of the total power, each of them to each side of the converter system.

### Configurations/Modifications

The system may be structured differently:

### Integrated Solution

In the integrated solutions, a machine may be split in different groups of windings. Each group is representing a three phase connection. One or more groups may be direct fed, while one or more may have a converter connection. An electric machine may be arranged with multiple three phase systems, e.g. a 9 phase system, with 3 phases connected via a converter and 6 phases connected direct.

### Systems Solutions

In one embodiment, one may use a physically decoupled system, where some parts are connected directly to the grid, while one or more parts are connected through a converter. The system control may be provided to control the power flow through the converter and the physical admission.

### Phase Configurations

The number of phases in each winding group may be different from one another within the same machine. A winding group may consist of a single phase winding, two phase windings, three phase windings or any other number of phase windings.

The windings within a winding group may be connected in a delta configuration, star (wye) configuration or any other configuration.

The neutral point of each winding group may be connected to each other. It can be a direct connection or a connection through some means of electric element, for instance a resistor, capacitor or a coil.

### Examples of Use

The invention may be used with a generator system powered by water or other kinds of energy. For one generator system, there may be multiple possibilities for dividing the system into a directly connected part and a converter connected part.

In electrical motors it is possible to use the converter part to bring the machine to a synchronous speed. When the speed is synchronous, the part for direct connection is connected. The system is operating like prior art synchronous machines with an auxiliary machine to achieve synchronous speed. The difference is the use of double fed windings of a stator of a PM machine. An example of this kind of system may be the propulsion system of a ship. In some systems the propellers are having a constant speed and adjustment of the deflection of the propeller blade. This type of system may be started with propellers of zero deflection with the converter and some of the windings. When the machine has a synchronous speed, then the part to be direct connected is engaged. In this way less expensive and more efficient propulsion is achieved.

A further version of this invention is used for double fed linear PSM machines. Generally this may provide the same advantages as described for rotating PMSM machines. This is further described with an example.

Linear machines are used in different markets and applications. One example is linear systems with a spring in each end, wherein resonance is involved. Such resonance systems are used for multiple applications. Common to some of these applications is the need for accelerating the system to the resonance velocity. When this velocity is achieved, the work or operation is conducted at this velocity. The invention with double fed stator may e.g. be used with linear machines with a frequency converter for starting. At the resonance frequency, the double fed windings are connected. The converter fed windings may provide control to the machine, together with control of the reactive power against the grid.

The converter connection to the PMSM can be used for damping, field weakening and monitoring. It can also be used in applications for braking or boosting a turbine at for instance startup, before it is connected to the grid.

### SUMMARY OF THE ADVANTAGES OF THE INVENTION

When lines are down, the novel system may operate independently.

The active power can be controlled at substantially lower cost.

The reactive power can be controlled at substantially lower cost.

It is possible to change between direct and converter feeding.

The invention may be used with multiple stators on a common shaft.

The invention may be used in systems with multiple machines, where one machine is converter fed and the remaining machine is direct fed.

Double feeding may be used for lowering the losses.

Braking of the machine can be done at full power although the converter is only rated for half the power.

The invention allows the replacing of a normal synchronous machine with a double fed permanent magnet synchronous machine.

What is claimed is:

1. Method for operating a permanent magnet synchronous machine, having more than one winding group, characterized in that at least one winding group is directly connected to a grid and at least one winding group has the possibility to be connected to the grid via a power electronics converter or directly.

2. Method according to claim 1, wherein the power of the converter is less than about 50% of the total power.

3. Method according to claim 1, wherein the converter is used for starting the machine.

4. Method according to claim 1, wherein the converter is used to control the active and reactive flow of power and for frequency control.

5. Method according to claim 1, wherein the converter is used for damping transients corresponding to the damping windings in prior art synchronous machines.

6. A system with a permanent magnet synchronous machine, as a motor or a generator, with a converter for feeding or withdrawal of power, wherein:
the converter is connected to a stator and provided for feeding or withdrawal of substantially less power than the maximum power of the system,
the machine has more than one winding group, and
at least one winding group is directly connected to a grid and at least one winding group has the possibility to be connected to the grid via the converter or directly.

7. A system according to claim 6, wherein the winding groups of the machine can be defined by segments of the machine, disks or dishes of the machine, separate machines or windings connected to different neutral points.

8. A system according to claim 6, wherein the converter is rated for less than about 50% of the total power.

9. A system according to claim 6, wherein the converter has a DC-link and a braking resistor connected to the DC-link.

10. A system according to claim 6, wherein each winding group has a neutral point, and the neutral points of each group are electrically connected to each other directly or through some means of electric element, for instance a resistor or a capacitor.

11. A system according to claim 6, wherein the winding groups connected to the converter have a different number of turns than the winding groups connected directly to the grid.

12. Method for braking the permanent magnet machine in a system according claims 6, wherein braking power can be applied to the machine by withdrawing power from one or more of the winding groups to feed a DC-link in the converter and dissipate it in a braking resistor connected to the DC-link.
